(19) United States
(12) Patent Application Publication
(10) Pub. No.: US 2006/0115192 A1
(43) Pub. Date: Jun. 1, 2006

(54) Bearing shell and method for the production thereof

(76) Inventor: Philippe Damour, Frankfurt/Main (DE)

Correspondence Address: Robert L Stearns;Howard & Howard, 39400 Woodward Ave, Suite 101, Bloomfield Hills, MI, 48304-5151, US

(21) Appl. No.: 10/539,671

(22) PCT Filed: Dec. 16, 2003
(86) PCT No.: PCT/DE03/04131

§ 371 Date: Jun. 14, 2005

(30) Foreign Application Priority Data
Dec. 17, 2002 (DE) 102 58 829.5

(51) Int. Cl. F16C 9/02

(52) U.S. Cl. 384/294

(57) ABSTRACT

Disclosed is a method for producing bearing shells, according to which blanks are produced from a strip material, whereupon said blanks are transformed into bearing shells and the bearing shells are provided with a lubricating layer. In order to be able to create a mark in an area that is visible once the bearing shell has been mounted, at least one engraved mark is introduced into the interior surface of the blank or the bearing shell within a strip-shaped region located below the partial area before the lubricating layer is applied. The depth and width of said engraved mark are selected such that the contour of the engraved mark is maintained once the lubricating layer has been applied.

The invention relates to a method of producing bearing shells, in which blanks are made from a strip material, then these blanks are shaped into a bearing shell, the inner surface is machined and finally these bearing shells are provided with an overlay. The invention also relates to such a bearing shell.

The strip material consists for example of a backing material, in particular of steel, and at least one bearing metal layer. Portions of material are cut from this strip material, an operation which is generally performed using a punching process.

Bearing shells have to be provided with a marking to indicate the specification, so that the buyer may assign a bearing shell to the particular internal combustion engine in which it is intended to be used.

There are various possible ways of doing this.

On the one hand, an appropriate marking may be applied to the rear of the bearing shell in the form of an alphanumeric code, a geometric marking or the like. This may be performed by means of stamping, a laser inscription method or an ink-based printing process. However, the bearing shell can no longer be identified after insertion in the housing.

It is therefore necessary for the marking to be applied at a location which is still visible after the bearing shell has been installed.

Examples of locations suitable for this purpose are the end face of the bearing shell or indeed the parting face thereof. However, the problem then arises that the available surface area is small, such that only small markings, e.g. in the form of recesses, may be applied. Although these may still be identified by an automatic image recognition system, they may impair the reliability of the plain bearing shell when in operation. These recesses have to be burr-free, which brings with it corresponding problems of manufacture, in particular when machining an end or parting face and the inner surface.

A further known method is to apply markings to the overlay even after coating thereof by means, for example, of an ink jet. This method used in series production has the disadvantage, however, that a separate method step is necessary to apply these markings. Such markings may also possibly become prematurely detached.

A plain bearing is known from DE 197 33285 A1, in which at least one depression is applied to the sliding surface as a marking, the depth T of which depression is ≦the maximum permissible surface roughness Rₜ. An area 40°-50° away from the parting face is proposed as the site for the marking. The marking consists substantially of a smoothing of the surface roughness of the overlay, for the production of which a dedicated method step with a marking element is necessary, the resilience of which must be no greater than the resilience of a measuring probe for measuring the wall thickness. This method is extremely sensitive and not wholly suitable for series production.

The object of the invention is therefore to provide a low-cost method for permanent application of a marking which is still visible after installation of the bearing shell, wherein the marking must not have a disadvantageous effect on the properties of the bearing shell in operation.

This object is achieved with a method in which at least one stamped marking is introduced into the inner surface of the blank or the bearing shell within a strip-shaped area below the parting face prior to application of the overlay, wherein the depth and width of the stamped marking have to be large enough for the contour of the stamped marking to be retained after application of the overlay.

The contour must be retained to the extent that it is still visible, in particular by an image recognition apparatus.

In contrast to stamped cams, oil grooves or oil reservoirs, a stamped marking does not have any properties which affect the sliding behavior of the bearing shell. Since the contour is not determined by hydrodynamic factors, for example, the stamped markings may be effected in any desired manner and may consist, for example, of abstract symbols, letters or numbers. The size of such stamped markings, i.e. their width B′ and their depth T′, depends merely on optical detectability, in particular by image recognition systems. The stamped markings have preferably to allow shadow formation, so allowing for example gray scale image processing in an image processing system. The contours of the stamped markings should also be large enough to enable resolution of the structure of the stamped marking on the one hand and the structures of stamped markings arranged next to one another on the other hand.

A stamped marking has the further advantage that it cannot disappear during transportation or handling by the buyer. If the stamped marking is large and deep enough still to be present after the coating process, identification by the buyer will be possible at any time.

So that a stamped marking, which constitutes an incursion into the bearing and/or backing material, does not have any disadvantageous consequences for operation of the plain bearing, it is advantageous for an unloaded or slightly loaded area of the bearing shell to be provided therefor. It has been demonstrated that a strip-shaped area below the parting face on the inside of the bearing shell is most suitable therefor, because this area is least loaded or not loaded at all by the counter-component. No impairment of the service life of the bearing shell could be noted in comparison with bearing shells without such stamped markings.

Such an unloaded area of the bearing shell is the “relief area”, which is formed by a bevel which tapers off towards the parting face and extends over the entire width of the bearing shell in order to compensate installation tolerances relating to the bearing cap and bearing housing. This relief area, which extends down from the parting face over a length L of approx. 3-10 mm, does not participate in mounting of the counter-component, such that the stamped marking does not impair the properties of the bearing shell.

The stamped marking is preferably introduced into the relief area prior to relief thereof.

Since the stamped marking is effected prior to application of the overlay, preferably prior to machining of the inner surface of the bearing shell, the depth and width of the stamped marking have to be such that the contour of the stamped marking is retained after application of the overlay, which may be applied by electroplating, for example, or using a sputtering method. This means that a “triangle” may still be identified as a “triangle” even after application of the overlay, an “A” may still be identified as an “A” and a “5” may still be identified as a “5” for example.

The stamped marking is preferably introduced in combination with a machining step which has to be performed anyway. It is thereby possible to integrate the stamped marking into series production, wherein no additional time is necessary for application of the stamped marking. This also prevents extra cost from being incurred.

The stamped marking is preferably introduced during punching out of the blank. Since this process also goes hand in hand with the punching out of oil holes or cams, for example, the stamped marking may also be introduced at the same time. All that is required therefor is an additional stamping tool.

The stamped marking may also be introduced during shaping of the blank into a bearing shell.

The stamped marking is preferably introduced with a depth T, such that after internal machining the depth T′ is ≧0.1 mm. If this depth T′ is complied with, it is ensured for conventional overlay thicknesses of 5-30 μm that the stamped marking is not filled so completely with the coating material that the stamped marking is no longer detectable after coating or the contour of the stamped marking has changed in such a way that the information content of the stamped marking is lost.

The stamped marking is preferably introduced with a depth T, such that after internal machining the depth T′ is > than twice the thickness D, in particular the maximum thickness, of the overlay.

It is advantageous with regard to the width B of the stamped marking for this width B to be such that, after internal machining, the width B′ is > twice the overlay thickness, in particular the maximum overlay thickness. B′ is preferably ≧0.1 mm.

Round or n-gonal contours, where n≧3, are preferably selected for the stamped marking, because these are generally best recognized by image, processing systems and thus unambiguous assignment may be ensured with a high degree of reliability.

The stamped marking is preferably introduced in the middle of the strip-shaped area. However, it is also possible to provide the stamped marking at the edge of the strip-shaped area.

The bearing shell according to the invention comprises at least one stamped marking in its inner surface within a strip-shaped area below the parting face. The stamped markings may be provided below one parting face or indeed below both parting faces. The bearing shell may consist of solid material or comprise a multilayer structure.

Exemplary embodiments of the invention are explained in more detail below with reference to the drawings, in which:

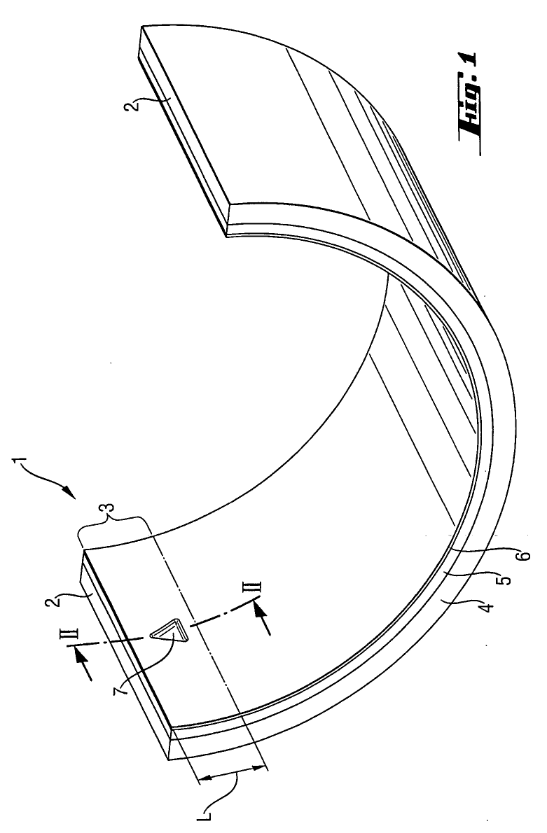

FIG. 1 shows a bearing shell with a stamped marking,

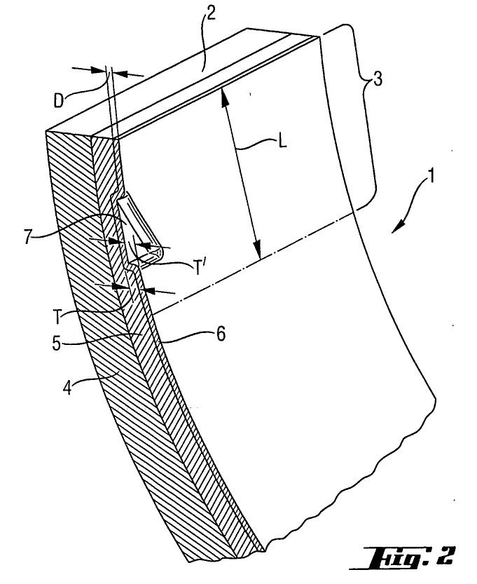

FIG. 2 shows a section through the bearing shell according to FIG. 1 along line II-II,

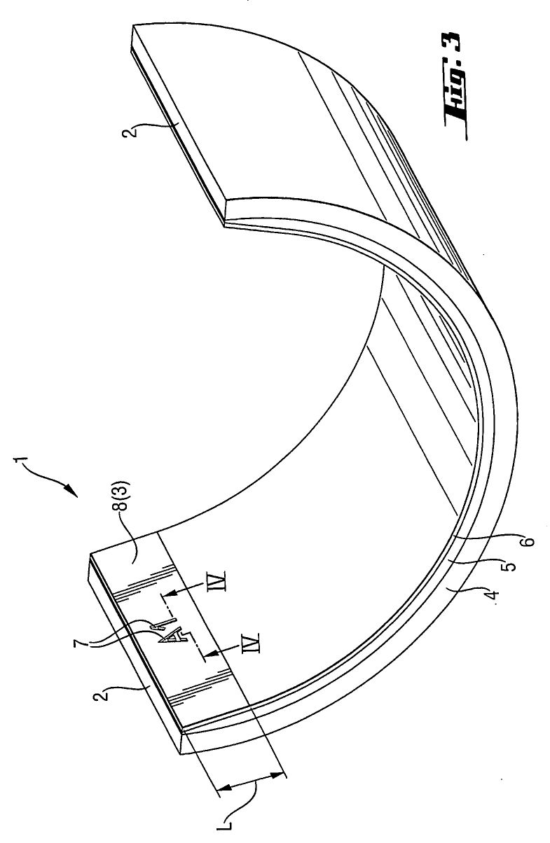

FIG. 3 shows a bearing shell according to a further embodiment and

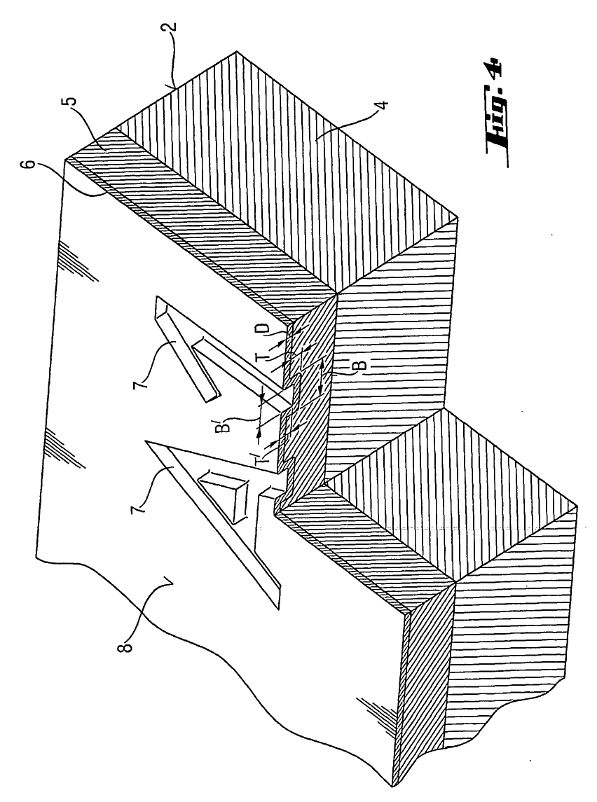

FIG. 4 is an enlarged representation of a partial section along line IV-IV of FIG. 3.

FIG. 1 is a perspective representation of a plain bearing shell 1 comprising a backing material 4, a bearing material 5 and an overlay 6, which may be applied by sputtering or electroplating. Below the parting face 2 a strip-shaped area 3 is drawn in, which identifies the unloaded area of the bearing shell 1 when in operation.

In the middle of this strip-shaped area 3 a triangular stamped marking 7 is visible, which was stamped into the bearing material 5 prior to application of the overlay 6. The length L of this strip-shaped area 3 ranges from 3-10 mm depending on the diameter of the bearing shell.

Stamped markings may also be provided on both sides, i.e. below both parting faces. The multilayer structure consisting of layers 4, 5 and 6 is also given by way of example. It is also feasible for intermediate layers to be provided, for example between the backing material 4 and the bearing material 5. The bearing shell may also consist of just one layer of material, which is coated with an overlay.

As is clear from FIG. 2, which shows a section along line A-A of FIG. 1, the depth T of the stamped marking 7 in the bearing material 5 is around twice the thickness D of the overlay 6, such that after the coating process a depth T′ remains, in which the stamped marking 7 is clearly visible. Typical overlay thicknesses are 5-30 μm.

FIG. 3 shows another embodiment of a bearing shell 1, which comprises a “relief area” 8 of the length L below the parting face 2. This comprises a bevel which tapers off towards the parting face 2 and which is identical to the strip-shaped area 3 in the representation shown here. Two stamped markings 7 are provided in the form of an “A” and a “1”, which are illustrated on an enlarged scale in FIG. 4 to explain the width B, B′.

FIG. 4 shows a portion along line IV-IV in FIG. 3. It is visible herein that the average width B of the stamped marking 7 introduced into the bearing material 5 has to correspond to at least twice the maximum thickness of the overlay 6, in order to achieve a visible stamped marking width B′ after completion of coating with the overlay 6. As far as the depths T and T′ respectively of the stamped marking 7 are concerned, fundamentally the same orders of magnitude apply as are described in the context of the first exemplary embodiment.

### REFERENCE NUMERALS

1 Bearing shell
2 Parting face
3 Strip-shaped area
4 Backing material
5 Bearing material
6 Overlay
7 Stamped marking
8 Relief area
9 Length of 3
T Depth prior to internal machining
T′ Depth after internal machining
B Width prior to internal machining
B′ Width after internal machining

1. A method of producing bearing shells in which blanks are made from a strip material, then these blanks are shaped into a bearing shell and finally these bearing shells are provided with an overlay, wherein
at least one stamped marking is introduced into the inner surface of the blank or the bearing shell within a strip-shaped area below the parting face prior to application of the overlay, wherein the depth and width of the stamped marking are sufficiently large for the contour of the stamped marking to be retained after application of the overlay.

2. A method according to claim 1, wherein the at least one stamped marking is introduced prior to machining of the inner surface.

3. A method according to claim 1, wherein a machining step is used in forming the bearing shell and where the at least one stamped marking is introduced in combination with the machining step.

4. A method according to claim 1, wherein the at lease one stamped marking is introduced during a punching out operation of the blank.

5. A method according to claim 1, wherein the at least one stamped marking is introduced during shaping.

6. A method according to claim 1, wherein the at least one stamped marking is introduced into a subsequently to be produced relief area of the bearing shell.

7. A method according to claim 1, wherein the at least one stamped marking is introduced with an initial depth T, such that after an internal machining operation the marking has a final the depth T′ of ≧0.1 mm.

8. A method according to claim 1, wherein the at least one stamped marking is introduced with an initial depth T, such that after an internal machining operation the marking has a final depth T′ that is > than twice a thickness D of the overlay.

9. A method according to claim 1, wherein the at least one stamped marking is introduced with a round or n-gonal contour, where n is ≧3.

10. A method according to claim 1, wherein the at least one stamped marking is introduced with a width B, such that after an internal machining operation the marking has a final width B′ that is > twice the thickness of the overlay.

11. A method according to claim 1, wherein the at least one stamped marking is introduced with a width B, such that after an internal machining operation the marking has a final width B′ that is ≧0.1 mm.

12. A method according to claim 1, wherein the at least one stamped marking is introduced in the middle of the strip-shaped area.

13. A method according to claim 1, wherein the at least one stamped marking is introduced at the edge of the strip-shaped area.

14. A bearing shell having at least one stamped marking in an inner surface within a strip-shaped area of the bearing shell below a parting face of the bearing.
